(19) United States
(12) Patent Application Publication
(10) Pub. No.: US 2002/0174590 A1
(43) Pub. Date: Nov. 28, 2002

(54) Illuminated soft plastic fishing system

(76) Inventors: Steven E. Nix, Houston, TX (US); Rebecca Nix, Houston, TX (US)

Correspondence Address: STEVEN E. NIX, 301E. 16ST, HOUSTON, TX, 77008, US

(21) Appl. No.: 09/866,344

(22) Filed: May 26, 2001

(51) Int. Cl. A01K 75/02; A01K 85/00

(52) U.S. Cl. 43/17.6

(57) ABSTRACT

A light emitting fishing system containing a removable and replaceable standerdized chemiluminescent cartridge for providing an illuminating fish attractant.

### DISCRIPTION OF THE PREFERRED EMBODIMENT

The illuminated plastic fishing system is comprised of two major components. The soft plastic lure body and the chemiluminescent capsule.

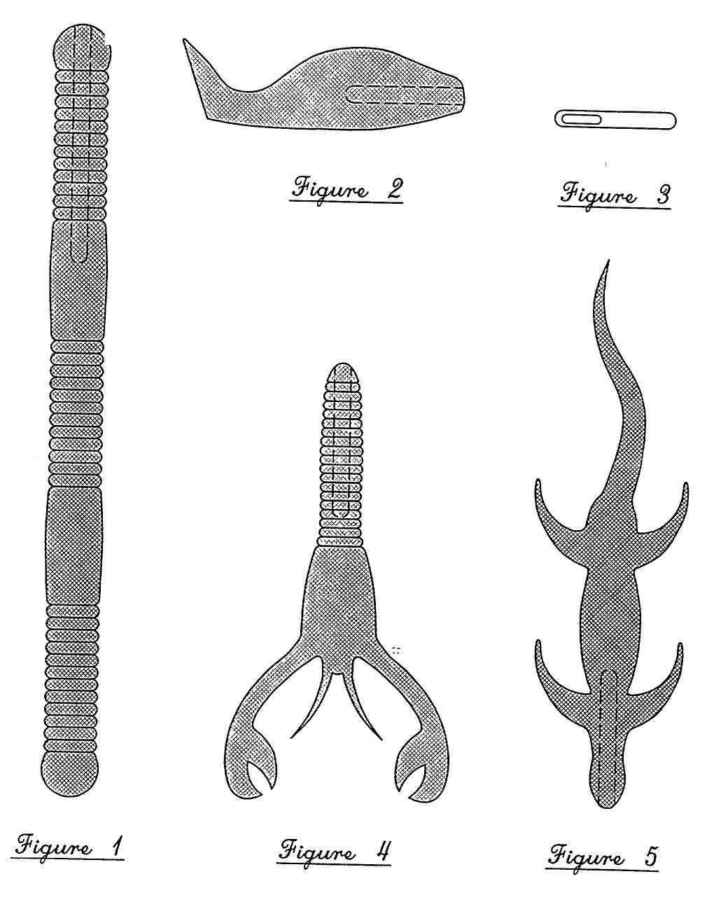

The soft plastic lure bodies (FIGS. 1, 2, 4, & 5) are made using a plastic extrusion mold method, with the lure bodies being of PVC resin with Plasticol added for flexibility. One of the innovations of this method is the creation of a chamber specifically designed to receive a chemical illuminescent device (FIG. 3); thereby creating a fiber optic effect in the lure. The chemiluminescent device is a plastic tube shaped article containing Oxalate.

When chemiluminescent capsule is bent the glass ampoule will break and activate the luminescent, creating visible light.

Once the chemiluminescent device has been activated, it is then inserted into the body of the lure by placing it in the chamber formed in the lure body by the mold.

After the chemiluminescent device ahs been placed into the body of the lure all that remains is for the fisherman to place a hook in the lure and fish.

1. An illuminated soft plastic fishing system comprised of:
A. A specially designed soft plastic lure body (see FIGS. 1, 2, 4, & 5) and
B. a self contained, chemically activated illumination source (see FIG. 3).
C. snap FIG. 3 between fingers and insert into lure body (FIGS. 1, 2, 4 & 5)
These items combined allow the artificial lure to carry the illumination source to any depth desired and attract the attention of aquatic life.
